(19) United States
(12) Patent Application Publication
(10) Pub. No.: US 2018/0127256 A1
(43) Pub. Date: May 10, 2018

(54) DRINK PRODUCING APPARATUS WITH SPECIFIC LINE SYSTEM AS WELL AS HOUSEHOLD REFRIGERATION APPARATUS

(71) Applicant: BSH HAUSGERAETE GMBH, Muenchen (DE)

(72) Inventors: KUDRET BAYSAL, GIENGEN BRENZ (DE); DELIA HAHN, HEIDENHEIM AN DER BRENZ (DE); MARCEL KIRSCHEN, GERSTHOFEN (DE); ANDREAS KLEINER, DORNSTADT (DE); CHRISTIAN MAYERSHOFER, GUNDREMMINGEN (DE); BERND METTEL, HERBRECHTINGEN (DE); CARSTEN WEISS, GIENGEN (DE)

(21) Appl. No.: 15/346,765

(22) Filed: Nov. 9, 2016

(51) Int. Cl. B67D 1/00; B01F 3/04; F25D 23/12; F25D 31/00

(52) U.S. Cl. CPC B67D 1/0066; B01F 3/04787; B01F 2003/049; F25D 23/126; F25D 31/002; B67D 1/0003

(57) ABSTRACT

A drink producing apparatus includes a dispensing unit for dispensing liquid, a dispensing container for receiving a liquid addable to a drink by the drink producing apparatus in a first liquid state, a conditioning container, in which the liquid can be conditioned into a second liquid state different from the first liquid state, a line device with a first line connection, wherein this first line connection is connected to the dispensing container and the dispensing unit, a second line connection connected to the dispensing container and the conditioning container, and comprises a recirculation line connection, wherein this recirculation line connection is connected to an input of the conditioning container and to an output of the conditioning container, wherein the line device comprises a line section, wherein this line section is a constituent of the first line connection and the second line connection and the recirculation line connection.

### TECHNICAL FIELD

The invention relates to a drink producing apparatus with a dispensing container, which is formed for receiving a liquid addable to a drink by the drink producing apparatus. The drink producing apparatus moreover includes a dispensing unit, to which the dispensing container is connected for supplying the liquid from the dispensing container to the dispensing unit. Furthermore, the invention also relates to a household refrigeration apparatus with such a drink producing apparatus.

### PRIOR ART

From DE 196 15 106 A1, a method and a device for continuously producing soda water or soda-like water are known. A device is disclosed there, in which different liquids like lemonade, beer, wine can be present in different separate containers. Each container is connected to an own tap and is thus separated from the other container. Producing and dispensing a mixed drink of different liquids in the containers is not possible there in the interior of the system itself. Furthermore, the taps are far apart such that introducing liquids from different taps into a drinking vessel at the same time is not possible.

From WO 2007/141321 A2, a household refrigeration apparatus is known, which has a drink apparatus, which is formed for dispensing a drink at this household refrigeration apparatus itself.

Moreover, cold drink machines are also known, in which alcohol containing mixed drinks, for example cocktails, can be dispensed.

In known drink producing apparatuses for dispensing cooled drinks, mixing of the liquid jet with other additions upon dispensing is restricted.

Especially carbonized and thus liquids mixed with carbonic acid lose carbonic acid in filling into the vessel, whereby the quality of the drink is decreased.

Moreover, hygienic requirements are also to be accommodated. In known implementations, the liquid can heat in the lines of a line device and germ growth can occur.

### PRESENTATION OF THE INVENTION

It is the object of the present invention to provide a drink producing apparatus as well as a household refrigeration apparatus, in which a line device in the apparatus is improved. It is also the object of the invention to more multi-functionally configure the line device and to more efficiently configure line paths as well as to improve the cooperation of line paths of the line device. It is also the object to perform the leading of liquid in the drink producing apparatus in particularly hygienic manner and to improve the cleaning of the components.

This object is solved by a drink producing apparatus and a household refrigeration apparatus according to the independent claims.

A first aspect of the invention relates to a drink producing apparatus. The drink producing apparatus has a dispensing unit for dispensing liquid from the drink producing apparatus. The drink producing apparatus has a dispensing container, which is formed for receiving a liquid addable to a drink by the drink producing apparatus in a first liquid state. The drink producing apparatus moreover has a conditioning container, in which the liquid can be conditioned in a second liquid state different from the first liquid state. The drink producing apparatus has a line device, which has a first line connection. This first line connection is connected to the dispensing container and the dispensing unit to lead the liquid between the dispensing container and the dispensing unit. Thereto, the line device has a second line connection different therefrom, wherein this second line connection is connected to the dispensing container and the conditioning container. Here too, a corresponding liquid leading of the second line connection is allowed. The line device has a recirculation line connection, wherein this recirculation line connection is connected to an input of the conditioning container and to an output of the conditioning container. By this recirculation line connection, a liquid in the conditioning container is recirculated and thereto led out of the conditioning container and into the recirculation line connection and then again led back into the conditioning container from it.

The line device has a line section, wherein this line section is a constituent of the first line connection and the second line connection and the recirculation line connection. This line section is therefore associated with three different line connections of the line device at the same time. By such a configuration of a drink producing apparatus, the entire line device becomes more multi-functional and the complexity with respect to the laying of the lines is reduced and the required line connections are minimized on the other hand such that the length of the line connections of the entire line device is also reduced. Thereby, installation space is also saved.

By such a configuration, the leading of liquid in the drink producing apparatus is allowed in particularly hygienic manner to a special degree. The cleaning of individual components of the drink producing apparatus, in which the liquid is located, is thereby also improved. A further aspect of the invention provides that the line device has a further recirculation line connection, wherein this further recirculation line connection is connected to an input of the dispensing container and to an output of the dispensing container. The line device has a line section, wherein this line section is a constituent of the first line connection and the second line connection and the recirculation line connection and the further recirculation line connection. Thus, it is provided that a single line section is a constituent of at least four different line connections of the line device. Thus, this line section represents a line path, which is used for four line connections.

A further aspect of the invention provides that the drink producing apparatus has a feed pump, in particular a high-pressure pump, which is arranged in this line section, which is employed for multiple different line connections of the line device, or installed therein. By this positioning of the feed pump at this exposed location, the feed of the liquid through the different line connections is advantageously possible. Since any liquid, which flows through one of these mentioned line connections, then also forcibly flows through the line section depending on situation, uniform feed is achieved by this position of the feed pump. Then, only one single such feed pump is also required to lead a liquid through a specific line connection in all of the situations, in which the very different line connections are provided for leading the liquid. The feed with this one feed pump at this exposed location is always allowed. Especially the feed pump is a bidirectional pumping unit.

It is also advantageous if the drink producing apparatus has a 4/2-way valve, wherein the 4/2-way valve is disposed in this mentioned line section of the line device. The coupling to other line parts of the line connections is therefore particularly simply possible and the respective possibilities of leading the liquid through one or more line connections are then particularly simply switchable. Flow paths through the line connections can then be individually unblocked or blocked in very adequate manner and the liquid can then still be led respectively through the line section. Alternatively instead of said 4/2-way valve the drink producing apparatus can comprise two 3/2-way valves. A further aspect of the invention provides that the 4/2-way valve has a first port and the first line connection has a line part, wherein the line part opens into the first port. This 4/2-way valve in particular has a second port, and the recirculation line connection has a recirculation line part, wherein the recirculation line part opens into the second port.

In particular, it is provided that the line part of the first line connection is a constituent of a further recirculation line connection of the line device, wherein this further recirculation line connection is connected to an input of the dispensing container and to an output of the dispensing container.

In particular, the 4/2-way valve has a third port, into which a drain line of the line device opens. Liquid can be led out of or discharged from the line device through this drain line.

In particular, stop valves are also provided, which are connected to the line section or installed in the line section such that the unblocking or blocking of specific areas is here allowed. The unblocking to line parts of the line connections or the blocking of these line parts of the line connections is therefore simply possible.

Preferably, the drink producing apparatus has a decompression chamber for pressure reduction of the liquid in the conditioning container. The decompression chamber is connected to the conditioning container by a line part of the line device. The carbonized liquid has a pressure in the conditioning container, which is too high for dispensing from the dispensing unit and there would result in undesired severe splash. In order to allow a user-friendly dispensing scenario here, pressure reduction is required, which is effected in this decompression chamber. Moreover, the drink producing apparatus can also have further valves, in particular a 3/2-way valve.

A further aspect of the invention relates to a drink producing apparatus, which has a dispensing unit for dispensing liquid from the drink producing apparatus. The drink producing apparatus has a dispensing container, which is formed for receiving a liquid addable to a drink by the drink producing apparatus in a first liquid state. The drink producing apparatus moreover has a conditioning container, in which the liquid can be conditioned in a second liquid state different from the first liquid state. Moreover, the drink producing apparatus has a line device, which has line connections to the dispensing unit, the dispensing container and the conditioning container. At least one of the line connections is a recirculation line connection, into which a liquid led therein can be recirculated without leading to the dispensing unit. A liquid contained in the container is led out of the container by this recirculation line connection and then also again in particular directly introduced in it and thereby the recirculation is performed. Thereby, particular hygienic requirements can be accommodated. The line device has at least one further line connection, which is a non-recirculation line connection, in which a liquid led therein cannot be recirculated. The recirculation line connection and the non-recirculation line connection are thermally coupled for transferring the temperature level of the recirculation line connection to the non-recirculation line connection. Thereby, particular hygienic aspects are accommodated and the cleaning as such is simplified. Because here the circulation of the liquid is virtually allowed by an own integrated purging process and thereby certain recirculation and avoiding microbial growth resulting therefrom is also achieved, especially if the non-recirculation line connection is cooled by the recirculation line connection.

Preferably, the thermal coupling between the recirculation line connection and the non-recirculation line connection is formed by lines laid parallel to each other, which are disposed in a common insulating body. It can also be provided that this thermal coupling is effected by coupling the line parts laid parallel to each other by a thermally leading tape, for example a metallic adhesive tape like an aluminum adhesive tape, such that an improved thermal transfer is effected thereby. A further possibility of this thermal coupling can be provided in that one of the two line connections is passed in the other line connection and thus a pipe-in-pipe system is virtually provided. In particular, it is provided that a stitch line connection, which cannot be purged and cooled independently of the drink dispensing, are laid thermally coupled to a recirculation line connection and in particular are insulated collectively with it. Thereby, the liquid in a stitch line connection can be indirectly cooled by the recirculation line connection and growth rates of microbial loads as low as possible are achieved in the stitch lines. Thereby, these stitch lines or stitch line connections also have to be purged more infrequently if they are not purged by the drink dispensing.

By the preferably provided cooling of such a stitch line connection too, the microbial growth and thus also the germ growth can be decelerated. Depending on specific cycles of this recirculation, it can also be provided in this context that depending on dispensing scenarios at the drink producing apparatus, these cycles are extended or shortened and then intermediate purging processes are optionally also performed. For example, this can be captured by corresponding sensors and controlled via a control unit.

In particular those are referred to as stitch line connections, which are laid for transporting the liquid, for example from the conditioning container, which can also be referred to as carbonizer, into the decompression chamber. Since the liquid is here slowly and controlled decompressed to ambient pressure to lose carbonic acid as little as possible and to achieve a dispensing jet as homogeneous as possible, this decompression chamber is provided. Similarly, a stitch line connection laid from the decompression chamber or from the dispensing container to the dispensing unit can be correspondingly designated. These stitch line connections are not regularly purged with fresh liquid, in particular fresh water or alcohol, and are virtually only purged if a new drink is to be dispensed. The line connections carrying carbonized liquids are only purged in dispensing an at least partially carbonized drink. Line connections carrying still water and thus still liquid, which is not carbonized, are only required in dispensing a drink having carbonization and thus only then correspondingly purged. Depending on these respective scenarios, the liquid in the stitch line connections can undesirably severely heat and thereby increased microbial growth can be caused, which is at least considerably inhibited by the mentioned aspects of the invention.

Especially also by the conception of the line device with intelligent interconnections and openings of the line connections of the line device, hygienic requirements can be accommodated in improved manner and the specific cleaning and purging of the line device can be improved. Moreover, a line device is also provided by the invention, which can be equipped more reduced, more compact and thus also with less valves and pumps with regard to its structure.

Especially if the drink producing apparatus is formed as a mixed drink producing apparatus and thus has and can dispense at least two separate different liquids, for example water and alcohol, the mentioned system with a dispensing container, a conditioning container and a line device is preferably dually present. This means that for each liquid, which is provided in the drink producing apparatus and then can be added to a mixed drink, a corresponding construction is preferably provided. The above mentioned aspects with the dispensing container, the conditioning container and a line device are explained for one such liquid in this respect and are at least duplicated if at least two such liquids can be dispensed. In particular, such a pump and in particular five valves are then provided per liquid side. A configuration of the entire system very reduced in components is thereby achieved. In particular, it is also allowed that the drink producing apparatus can cause to circulate the liquid in the line device in two different flow directions such that the flow direction is also reversible in this respect. Thereby, the cleaning of the system is also significantly improved.

A further aspect of the invention relates to a drink producing apparatus, which has a dispensing unit for dispensing liquid from the drink producing apparatus. The drink producing apparatus has a dispensing container, which is formed for receiving a liquid addable to a drink by the drink producing apparatus in a first liquid state. The drink producing apparatus has a conditioning container, in which the liquid can be conditioned in a second liquid state different to the first liquid state. The drink producing apparatus has a line device, which has a first line connection, wherein this first line connection is connected to the dispensing container and the dispensing unit. The line device has a second line connection, wherein this second line connection is connected to the dispensing container and the conditioning container. The line device has a recirculation line connection, wherein this recirculation line connection is connected to an input of the dispensing container and to an output of the dispensing container. The line device has a line section, wherein this line section is a constituent of the first line connection and the second line connection and the recirculation line connection.

In the respectively mentioned aspects of the invention, a first liquid state of the liquid is a non-carbonized state and a second liquid state is a carbonized liquid state.

Preferably, it is provided that the drink producing apparatus has a capsule with an addition medium separate from the dispensing container, which can then be added to the jet of the liquid in producing the mixed drink. Such an addition medium can be liquid, gelatinous or powdery. In this context, addition media individual both in taste and in color can then be present, which impart corresponding specifications to the mixed drink.

In particular, it is provided that the drink producing apparatus has at least one second dispensing container, which is formed for receiving a second liquid addable to the in particular cooled mixed drink by the drink producing apparatus, wherein this second dispensing container is connected to the dispensing unit of the drink producing apparatus for leading the second liquid from the second dispensing container to the dispensing unit, wherein the first liquid and the second liquid are mixed to the jet dispensed from the dispensing opening. In this configuration, thus, a mixed drink of two different liquids is already present at the dispensing opening, which can then in particular be mixed with the jet of the addition medium from the capsule.

It can be provided that a liquid, in particular the first liquid, is water or contains water and the second liquid is alcohol or contains alcohol.

In particular, the two liquids also have different freezing points.

In particular, the first dispensing container is cooled by a cooling device of the drink producing apparatus. The cooling device is in particular a refrigeration circuit. The refrigeration circuit in particular includes an evaporator thermally coupled to the dispensing container such that the dispensing container can be cooled by the cold energy of the evaporator and thus the first liquid in particular present in the dispensing container is then also cooled thereby.

In particular, the preferably present second dispensing container can also be cooled by the cooling device. Here too, the thermal coupling to a refrigeration circuit is in particular provided, which is preferably the refrigeration circuit, by which the first dispensing container is also cooled. Here too, it is preferably provided that the second dispensing container is thermally coupled to an own, separate evaporator and is cooled via the cold energy thereof. Especially if the two liquids have different freezing points, the cooling with separate cooling units, in particular separate evaporators, is advantageous to be able to individually adjust adequate temperatures without one of the two liquids freezing.

Implementations of an independent aspect of the invention relating to the drink producing apparatus are to be regarded as advantageous implementations of the other independent aspects of the drink producing apparatus.

Furthermore, the invention also relates to a household refrigeration apparatus for storing and preserving food, which has a housing, in which a receiving space for food is formed. The household refrigeration apparatus moreover includes a drink producing apparatus according to the first independent aspect of the invention or according to the second independent aspect of the invention. The household refrigeration apparatus can be a refrigerator or a freezer or a combined refrigerator-freezer.

In addition, it can also be provided that the drink producing apparatus is formed for receiving a capsule, in which additives, which can be added to the mixed drink, are contained. Additives can be powdery or gelatinous or also liquid. In this context, the capsule can then be introduced into a dispensing area of the drink producing apparatus and this ingredient of the capsule can then also be automatically dispensed or admixed or already be admixed upon dispensing the mixed drink.

In an advantageous implementation, it is provided that the drink producing apparatus is disposed in a receiving area of the household refrigeration apparatus in particular separate from the receiving space for food. This receiving area can be formed in an interior container bounding the receiving space with its walls. However, it can also be provided that the receiving area is formed in an interior container separate from this interior container bounding the receiving space with its walls. These interior containers or this interior container are or is disposed in the housing.

The receiving space, in particular only the receiving space, is closable on the front side by a door pivotably supported at the housing. In this context, it can be provided that the household refrigeration apparatus is formed such that only one receiving space is present, which is for example a refrigerating compartment or a freezing compartment, which is closable by an own door. However, it can also be provided that such a single receiving space is closable by two doors, which are swing doors. However, it is similarly possible that with two separate receiving spaces, for example a refrigerating space and a freezing space, each of these receiving spaces is closable by a separate door.

Preferably, the drink producing apparatus is accessible on the front side and exposed and not closed and covered by a door.

In an advantageous implementation, it is provided that the drink producing apparatus is arranged drawer-like in the receiving space and thus is retractable and extractable in depth direction of the household refrigeration apparatus. Thereby, the operability for dispensing mixed drinks can be simplified. An essential advantage of this configuration is to be regarded in that the accessibility to the housing of the mixed drink producing apparatus is simplified. In particular the accessibility to the containers and/or other further components in the housing is thereby allowed. It can then be provided that in the extracted state the interior of the housing of the drink producing apparatus can be accessed for example via openings in side walls closable by flaps.

The drink producing apparatus is also to be referred to as mixed drink producing apparatus if the drink to be dispensed has at least one liquid and an addition medium or at least two different liquids.

With indications of “top”, “bottom”, “front”, “rear”, “horizontal”, “vertical”, “depth direction”, “width direction”, “height direction” etc., the positions and orientations with intended use and intended arrangement of the apparatus and with an observer then standing in front of the apparatus and looking towards the apparatus are specified.

Further features of the invention are apparent from the claims, the figures and the description of figures. The features and feature combinations mentioned above in the description as well as the features and feature combinations mentioned below in the description of figures and/or shown in the figures alone are usable not only in the respectively specified combination, but also in other combinations without departing from the scope of the invention. Thus, implementations are also to be considered as encompassed and disclosed by the invention, which are not explicitly shown in the figures and explained, but arise from and can be generated by separated feature combinations from the explained implementations. Implementations and feature combinations are also to be considered as disclosed, which thus do not have all of the features of an originally formulated independent claim. Moreover, implementations and feature combinations are to be considered as disclosed, in particular by the implementations set out above, which extend beyond or deviate from the feature combinations set out in the relations of the claims.

### BRIEF DESCRIPTION OF THE DRAWINGS

Below, embodiments of the invention are explained in more detail based on schematic drawings. There show:

FIG. 1 a perspective partial representation of an embodiment of a household refrigeration apparatus according to the invention;

FIG. 2 a schematic representation of partial components of an embodiment of a drink producing apparatus according to the invention as it can be installed in the household refrigeration apparatus according to FIG. 1; and

FIG. 3 a schematic representation of partial components of an embodiment of a drink producing apparatus according to the invention.

### PREFERRED EMBODIMENTS OF THE INVENTION

In the figures, identical or functionally identical elements are provided with the same reference characters.

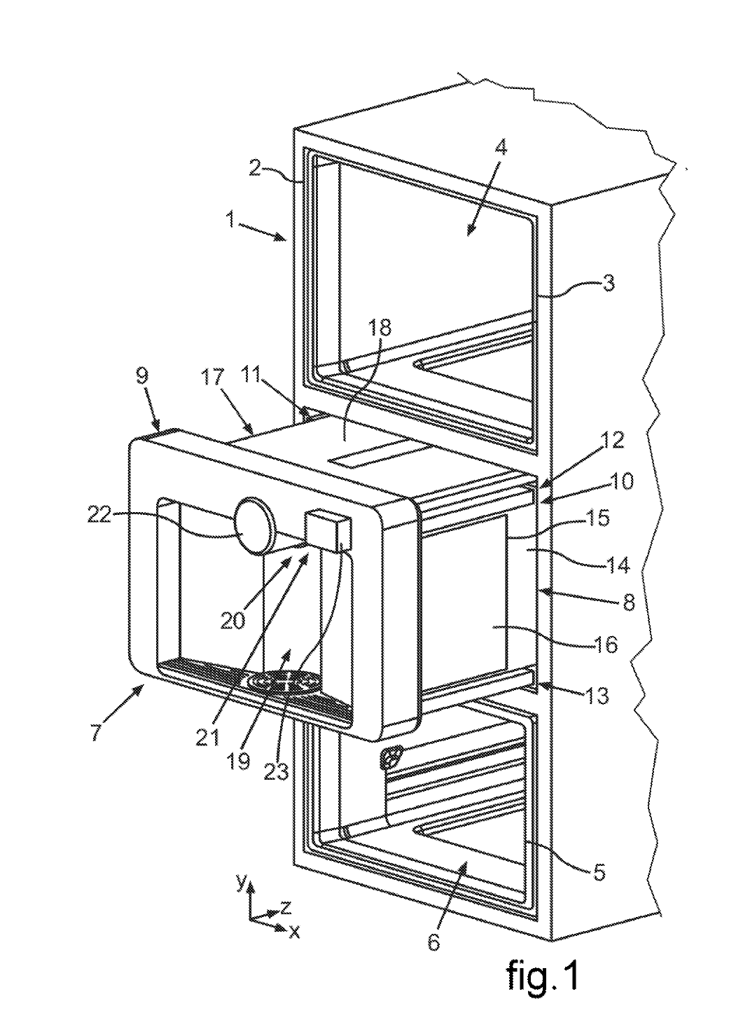

In FIG. 1, an embodiment of a household refrigeration apparatus 1 is illustrated in certain areas in a simplified perspective representation. Here, the household refrigeration apparatus 1 is for example a combined refrigerator-freezer, but can also be only a refrigerator or a freezer. The household refrigeration apparatus 1 is formed for storing and preserving food. It includes a housing 2, in which a first interior container 3 is disposed. Walls of the interior container 3 bound a first receiving space 4 for food, wherein this receiving space 4 is a refrigerating compartment.

Moreover, the household refrigeration apparatus 1 includes a further interior container 5, which bounds a second receiving space 6 with its walls, which is a freezing compartment. The two receiving spaces 4 and 6 are separated from each other. In the shown embodiment, the receiving spaces 4 and 6 are disposed one above the other in vertical direction and thus in height direction (y-direction). In the embodiment, they are preferably closable by non-shown, respectively separate doors, which are in particular pivotably fastened to the housing 2.

Moreover, the household refrigeration apparatus 1 includes a drink producing apparatus 7, which is a mixed drink producing apparatus in the embodiment.

However, the drink producing apparatus 7 can also be formed as a separate independent apparatus and thus be installed independently of a household refrigeration apparatus 1 and operable independently thereof.

The drink producing apparatus 7 is disposed in a receiving area 8 of the housing 2. This receiving area 8 is separated from the receiving spaces 4 and 6. It can be provided that the receiving area 8 is bounded by walls of a separate interior container, which is also foamed in the housing 2. However, the receiving area 8 can also be formed integrated in the interior container 3 or the interior container 5.

In the embodiment, it is provided that the receiving area 8 is disposed between the receiving space 4 and the receiving space 6 in height direction.

The drink producing apparatus 7 is disposed accessible from the front side and thus from the front and the visible side. In particular, it is not closable and thus not coverable on the front side by a door.

The drink producing apparatus 7 has a housing 9.

In the embodiment, it is provided that the housing 9 and thus the entire mixed drink producing apparatus 7 can be extracted from and again retracted into the receiving area 8 in depth direction and thus in horizontal direction corresponding to the z-direction corresponding to a drawer. In FIG. 1, the completely extracted state is shown. However, the apparatus 7 can also be disposed fixedly installed.

Here, it is preferably provided that the horizontal displaceability is formed by a displacing device 10, which has multiple supporting positions. In the embodiment, it is provided that the displacing device 10 includes at least two, in particular four supporting positions. In the embodiment, they are formed as rails, which can also be extraction rails. In particular, here are disposed a first rail 11 in an upper left corner area, a second rail 12 in the upper right corner area, a third rail 13 in the lower right corner area and a further rail not recognizable in FIG. 1 in the lower left corner area. By this four-position support, a very secure and spread- and tilt-proof displacement, respectively, of the housing 9 is allowed.

Thus, the drink producing apparatus 7 is advantageously displaceably supported in the interior container 8. Advantageously, the displacing device 10 also has an extraction stop, by which the drink apparatus formed in particular as a drink producing apparatus 7 is secured in position in a completely extracted position shown in FIG. 1. Thus, over-extraction cannot be effected such that the drink producing apparatus 7 cannot fall out to the front and tilt downwards, respectively.

Advantageously, it is also provided that the displacing device 10 has a displacing protection, by which the drink producing apparatus 7 is disposed extraction-secured in the position completely retracted into the receiving area 8. Thereby too, undesired slipping out or protruding to the front then present is avoided. Undesired leakage or dripping of a liquid or hitting thereto is thereby prevented. This displacement protection can be a locking device. However, in addition or instead, a magnetic mount can for example also be provided.

Advantageously, an access 15 is formed at a vertical sidewall 14 of the housing 9, which is closed by a flap 16. After opening the flap 16, the interior of the housing 9 can be accessed such that the simple and unrestricted accessibility is allowed for purposes of exchange or filling. Additionally or instead, it can also be provided that a corresponding access is formed at an opposing further vertical sidewall 17 and/or at least one such access 15 is formed at a ceiling wall 18 of the housing 9.

Moreover, the drink producing apparatus 7 includes a recess or placing bay 19 on the front side, into which a drinking vessel can be placed, by which the mixed drink to be produced and dispensed by the drink producing apparatus 7 can then be collected. The drink producing apparatus 7 includes a dispensing unit 20 with in particular a single outlet or a dispensing opening 21. Preferably, it can be provided that an own outlet is respectively present for discharging each liquid from a container. Moreover, it can also be provided that an additive in powder form or gel form or further liquid form can additionally be admixed to this mixed drink to be produced, which can be produced and thus mixed from at least two different liquids. Thereto, it can in particular be provided that a capsule receptacle 22 is formed, into which a capsule having the mentioned additive or an addition medium can be inserted. Upon dispensing the mixed drink, this ingredient or additive is then removed from the capsule and added to the mixed drink in particular after dispensing into the drinking vessel effected via the dispensing opening 21.

Moreover, it can in particular be provided that the drink producing apparatus 7 has a capsule storage 23 or a capsule stock. A capsule or multiple capsules can be stored in this capsule storage 23 such that they are always present locally at the apparatus itself. In an advantageous implementation, it can be provided that this capsule storage 23 is cooled such that the capsules located therein can also be stored correspondingly cooled.

Preferably, it is provided that the capsule storage 23 can be opened by push-push mechanics and the capsules received therein are then freely accessible for example in the form of a displaceable storage in the form of a rail and for example can then be simply removed from above.

Moreover, it can also be provided that the drink producing apparatus 7 has a cartridge for admixing carbon dioxide into the mixed drink. Thereto, the accessibility for cartridge exchange is allowed via at least one present access 15. In an advantageous implementation, it is provided that the drink producing apparatus 7 is connected to a water connection external to household apparatus such that supply of water is for example allowed via a house water network. This has the additional advantage that a liquid to be added to the mixed drink as water does not have to be stored in a largely dimensioned container in the drink producing apparatus 7 but that this container can then be smaller dimensioned and can be refilled depending on demand and adapted to situation. It can then also be provided that such a water supply for producing the mixed drink is not supplied from the tank or the container provided for receiving this liquid in the drink producing apparatus 7, but additionally or instead can also be passed directly from this line to the dispensing unit 20 and thus also to the dispensing opening 21.

Thereby, in particular in production of hot drinks instead of a cold drink, the required energy for heating is reduced since the initial temperature of the water is higher. If carbonization of the mixed drink should then be desired, thus, this can be allowed via admixture of carbonized cold water, which is cooled in the drink producing apparatus 7, or by a carbonized second liquid, which is then present in the second container.

It is in particular provided that the drink producing apparatus 7 has a first container, in which a first liquid with a first freezing point, in particular water, is then provided or stored to then provide it for producing and dispensing a mixed drink depending on demand. Moreover, the drink producing apparatus 7 includes a second container separated therefrom, which is formed for receiving a second liquid different from the first liquid, which has a freezing point different form the first liquid. In particular, the first liquid is water and the second liquid is alcohol such that the mixed drink can also be an alcoholized mixed drink.

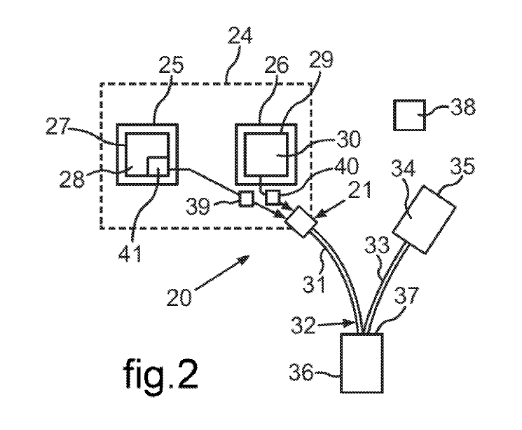

In FIG. 2, the household refrigeration apparatus 1 is shown with partial components of the drink producing apparatus 7 in a schematic representation. The household refrigeration apparatus 1 includes a refrigeration circuit 24, which is in particular a refrigeration circuit of the drink producing apparatus 7. In an advantageous implementation, this refrigeration circuit 24 includes a non-illustrated condenser, a compressor as well as a first evaporator 25 and a second evaporator 26 separate therefrom. The mixed drink producing apparatus 7 includes a first container or dispensing container 27, which is formed for receiving the first liquid 28 addable to the mixed drink, in the embodiment. The first dispensing container 27 is thermally coupled to the refrigeration circuit 24, in particular thermally coupled to the first evaporator 25. In an advantageous implementation, the first evaporator 25 surrounds the first dispensing container 27 on the outer side thereof at least in certain areas.

In the embodiment, it is provided that the drink producing apparatus 7 has a second container or dispensing container 29 separate from the first dispensing container 27, which is formed for receiving a second liquid 30 different from the first liquid, which can also be added to the mixed drink. Here too, it is preferably provided that the second evaporator 26 is thermally coupled to the second dispensing container 29, in particular surrounds it on the outer side thereof at least in certain areas.

In particular, it is provided that the first liquid 28 is or has water and the second liquid 30 is or contains alcohol.

In FIG. 2, dispensing of the two liquids 28 and 30 from the dispensing containers 27 and 29 is then illustrated by arrows in sketchy manner in the schematic representation, and the two liquids 28 and 30 are mixed to a common liquid jet 31 in an advantageous implementation. However, dispensing of a jet of only one of the two liquids 28 and 30 can also be provided.

In particular, it is provided that the jet 31 is formed after exit from the dispensing opening 21 at a place of meeting 32 with a jet 33 of an additive or addition medium 34, which is contained in a capsule 35 disposed in the mixed drink producing apparatus 7, after the dispensing opening 21, but before entry into a receiving vessel 36 with regard to the height position viewed in vertical direction. In particular, this place of meeting 32 is above a border 37 of the receiving vessel 36 in vertical direction. Mixing between the jet 31 and the jet 33 then desirably improved already before entry into the receiving vessel 36 is thereby achieved.

Therein, the receiving vessel 38 is placed in the placing bay 19 (FIG. 1).

The drink producing apparatus 7 also includes a control unit 38 for controlling the dispensing of the mixed drink.

In FIG. 2, it is preferably also provided that in the partial system, in which the liquid 28 is stored and led, a decompression chamber 39 is arranged. It is in particular arranged between the dispensing container 27 and the dispensing unit 20. The then in particular carbonized first liquid 28 is led into the decompression chamber 39 before leading out of the dispensing opening 21 and there reduced in its pressure. In particular, pressure reduction to about 2 bar is performed in the decompression chamber 39.

In an advantageous implementation, it is in particular provided that in addition or instead a further decompression chamber 40 is provided. It is arranged in the partial area or the system, in which the second liquid 30 is stored and led. It is correspondingly arranged between the further dispensing container 29 and the dispensing unit 20, in particular the dispensing opening 21. There too, pressure reduction can then be effected in the decompression chamber 40 if the second liquid 30 is provided in carbonized manner, in particular also again preferably to a pressure of about 2 bar.

In the schematic representation in FIG. 2, it is already apparent that in an embodiment, in which the drink producing apparatus 7 is formed as a mixed drink producing apparatus and thus provides two different liquids 28 and 30, which can be added to a drink to be dispensed, two separated systems are present, which provides storing and leading a liquid in the drink producing apparatus 7. These systems are preferably then respectively identically constructed and then each have the same or similar components in this context.

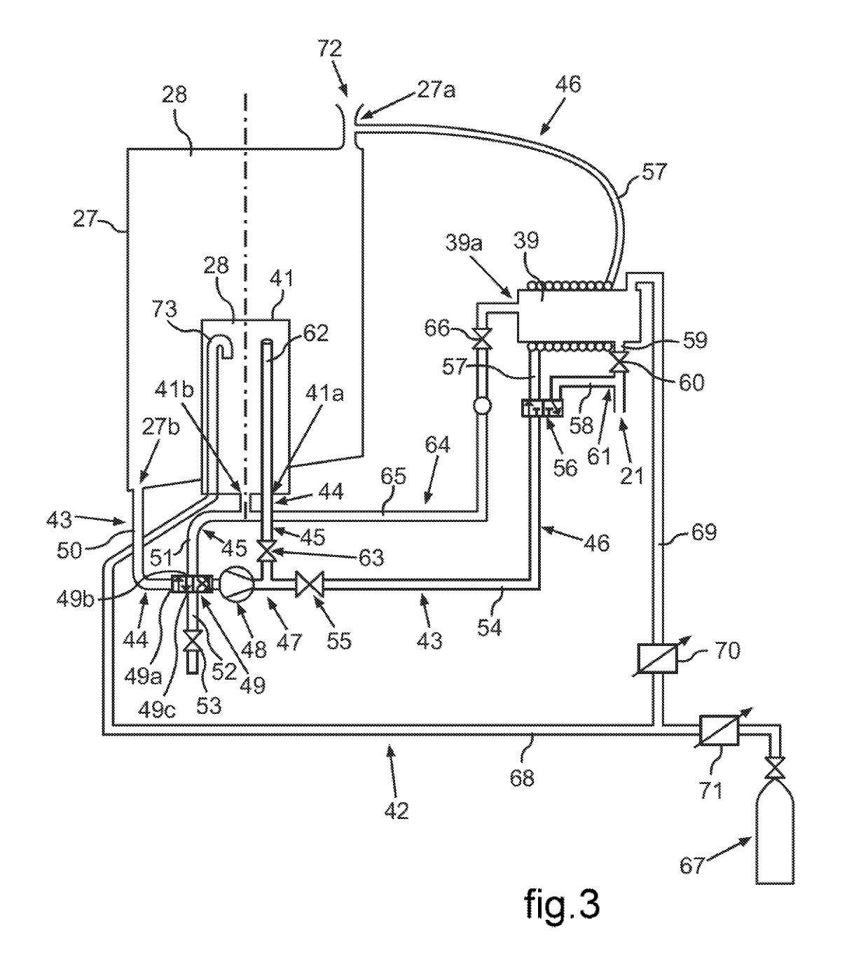

In FIG. 3, the drink producing apparatus 7 with partial components is shown in a schematic representation. In this context, it is to be mentioned that for example that system part is illustrated here, in which the first liquid 28 is stored and led. A corresponding construction, as it is shown in FIG. 3 and explained below, is then also present for the second liquid 30 in the drink producing apparatus 7 in corresponding manner. An explanation thereto is not explicitly performed and the facts set forth to FIG. 3 for one system part then also apply to this further system part, in which the second liquid 30 is stored and led.

In FIG. 3, the dispensing container 27 is shown, in which the first liquid 28 is contained in a first liquid state. This first liquid state is a non-carbonized state.

Moreover, a conditioning container 41 is shown in FIG. 3, which is separated from the dispensing container 27. This first liquid 28 is conditioned and provided in a second liquid state in this conditioning container 41, respectively. This second liquid state is a carbonized state.

The system shown in FIG. 3 moreover shows a line device 42 generally provided with the reference character, which represents a line network, by which the different components in the form of the dispensing container 27, the conditioning container 41 and the decompression chamber 39 are connected in fluid leading manner. In particular, the dispensing unit 20 with the dispensing opening 21 is also coupled to this line device 42 such that corresponding fluid leading connections to the dispensing container 27, the conditioning container 41 and the decompression chamber 39 exist here too.

The line device 42 has a first line connection 43, which is connected to the dispensing container 27 and the dispensing unit 20. Thus, the liquid 28 can be also directly led from the dispensing container 27 to the dispensing opening 21 via this first line connection 43. Thereby, the first liquid 28 can be led directly to the dispensing opening 21 from the dispensing container 27 without detour via the conditioning container 41 and without detour via the decompression chamber 39.

Moreover, the line device 42 includes a second line connection 44. The second line connection 44 is connected to the dispensing container 27 and the conditioning container 41. Moreover, the line device 42 includes a recirculation line connection 45. This recirculation line connection 45 is connected to an input 41a of the conditioning container 41 and to an output 41b of the conditioning container 41. The carbonized liquid 28 located in the conditioning container 41 in the second liquid state is circulated via this recirculation line connection 45.

In the embodiment, it is provided that the line device 42 additionally has a further recirculation line connection 46. This further recirculation line connection 46 is connected to an input 27a of the dispensing container 27 and to an output 27b of the dispensing container 27. The first liquid 28 contained in the dispensing container 27 in the first liquid state can be circulated via this further recirculation line connection 46.

An embodiment can also be provided, in which this further recirculation line connection 46 is not present. Similarly, an embodiment can be provided, in which the recirculation line connection 45 is not present, but the recirculation line connection 46 is then present.

The line device 42 has a line section 47, which is a constituent of the first line connection 43 and a constituent of the second line connection 44 and a constituent of the recirculation line connection 45. In the shown embodiment, it is moreover provided that this line section 47 is also a constituent of the further recirculation line connection 46 at the same time. This means that this line section is a simultaneous constituent of four line connections separately connected to different components of the drink producing apparatus 7.

A feed pump 48 is arranged in this line section 47, wherein it is in particular provided that this feed pump 48 is the only pump of the line device 42. This feed pump 48 is preferably a high-pressure pump. In particular, this line section 47 also has a 4/2-way valve 49. As is apparent, a line part 50, which opens into the output 27b of the dispensing container 27, is connected to a first port 49a of this 4/2-way valve 49. This line part 50 is a constituent of the first line connection 43 and also represents a constituent of the further recirculation line connection 46 in the embodiment.

Moreover, the line device 42 has a line part 51, which is connected to the output 41b of the conditioning container 41 and to a second port 49b of the 4/2-way valve 49. This line part 51 is also a recirculation line part of the recirculation line connection 45.

Moreover, the line device 42 includes a further line part 52, which represents a drain line. This line part 52 opens into a third port 49c of the 4/2-way valve 49. As is moreover apparent, a stop valve 53 is disposed in this line part 52, by which the drain or discharge of liquid from the line device 42 can be unblocked or stopped.

In flow direction of the first liquid 28, a further line part 54 is disposed after the first line part 50 and after the line section 47, which is a constituent of the first line connection 43 and is also a constituent of the further recirculation line connection 46 at the same time in the embodiment. This line part opens into a further stop valve 55, which is connected to the line section 47 on the other hand. Moreover, it is provided that this line part 54 opens into a further valve 56, wherein this further valve 56 is in particular a 3/2-way valve. As is furthermore apparent, a further line part 57 is connected to this further valve 56 on the one hand, connected to the input 27a of the dispensing container 27 on the other hand. Moreover, this line part 57 is laid multiple times turning around the outer side of the decompression chamber 39 such that a corresponding thermal coupling between this line part 57 and the decompression chamber 39 is achieved. In particular, cooling of the liquid in the decompression chamber 39 is thereby achieved since the first liquid 28 is preferably cooled stored in the dispensing container 27.

This line part 57 is therefore a constituent of the further recirculation line connection 46.

Moreover, a line part 58 is provided, which also opens into the valve 56 and is connected to the dispensing opening 21 on the other hand. This line part 58 is preferably then also a constituent of the first line connection 43, via which the first liquid 28 can be led from the dispensing container 27 then directly to the dispensing opening 21.

As is moreover apparent, the decompression chamber 39 also opens into the dispensing opening 21 by a line part 59. Thereby, the medium dispensed from the decompression chamber 39, namely the carbonized liquid 28 then brought to a lower pressure level, can be led directly to the dispensing opening 21. Here, it is in particular provided that a further stop valve 60 is arranged on the line path between the decompression chamber 59 and the dispensing opening 21. This stop valve 60 is preferably arranged upstream of an opening 61 in flow direction, at which the line part 58 opens into the line opening into the dispensing opening 21.

Moreover, it is provided that the recirculation line connection 45 has a line part 62 as a recirculation line part, which joins to the line section 47 downstream of it in flow direction of the liquid 28. Here too, it is provided that a further stop valve 63 is arranged between the line section 47 and this line part 62.

A further line connection 64 is formed between the conditioning container 41 and the decompression chamber 39. Thereto, a line part 65 is provided here too, which extends between an output 41b of the conditioning container 41 and an input 39a of the decompression chamber 39. Here, it is in particular provided that a valve 66 is arranged in this line part 65, which is also preferably a stop valve.

As is moreover shown in an example, the drink producing apparatus 7 includes a CO₂ container 67, by which carbon dioxide addition can be effected via a further line 68 to the conditioning container 41. In the embodiment, it is moreover provided that a connection between the container 67 and the decompression chamber 39 is formed via a further line part 69. Corresponding pressure controllers 70 and 71 are present in the line parts.

In the embodiment shown here, it is provided that the first line connection 43 has the line part 50, the line section 47, the line part 54 and the line part 58.

The second line connection has the line part 50, the line section 47 and the line part 62 in the shown embodiment.

The recirculation line connection 45 has the line part 51, the line section 47 and the line part 62 in the shown embodiment.

The further recirculation line connection 46 has the line part 50, the line section 47, the line part 54 as well as the line part 57, which are then recirculation line parts, in the shown embodiment.

In this context, a plurality of further line parts are also present in the embodiment, which are not associated with only one single line connection, but which are constituent of at least two line connections of the line device 42. The stop valves 55 and 63 each have two ports, into which the line section 47 opens at the one hand, further line parts 54 and 62, respectively, open at the other hand.

In an advantageous implementation, it is provided that at least one recirculation line connection is thermally coupled to a non-recirculation line connection such that the temperature level of the recirculation line connection can be transferred to the non-recirculation line connection. In this context, the thermal coupling can be realized by a heat exchanger, for example a thermally leading adhesive tape, which is preferably formed as a metallic adhesive tape. The thermal coupling between a recirculation line connection and a non-recirculation line connection can also be realized in a common insulation, which means that these two line connections are then surrounded by a common insulation. Similarly, it is possible that the thermal coupling between a recirculation line connection and a non-recirculation line connection is formed by a pipe-in-pipe system.

For example, it can be provided that a thermal coupling is formed between the line part 65 and the line part 54. In addition or instead, a thermal coupling can also be provided between the line part 65 and the line part 57. Preferably, pressure regulation to 2 bar is possible in the line part 69 such that the liquid then present in the decompression chamber 39 is reduced to a corresponding pressure level. On the other hand, it can be provided that a pressure of about 4 bar is set by the pressure controller 71 such that the first liquid 28 in the conditioning container 41, in which the liquid 27 is conditioned with the carbon dioxide, is on a correspondingly high pressure level.

Moreover, the dispensing container 27 has a filling opening 72, via which the first liquid 28 can be introduced. In particular, a filter can also be additionally present there.

Moreover, it can be provided that a check valve is also arranged in a line part 73 opening into the conditioning container 41, which introduces the carbon dioxide from the container 67.

Moreover, the line part 62 can have a nozzle for atomizing the liquid 28 to be introduced.

### LIST OF REFERENCE CHARACTERS

1 Household refrigeration apparatus

2 housing

3 interior container

4 first receiving space

5 interior container

6 second receiving space

7 mixed drink producing apparatus

8 receiving area

9 housing

10 displacing device

11 rail

12 rail

13 rail

14 sidewall

15 access

16 flap

17 sidewall

18 ceiling wall

19 placing bay

20 dispensing unit

21 outlet

22 capsule receptacle

23 capsule storage

24 refrigeration circuit

25 first evaporator

26 second evaporator

27 first dispensing container

28 first liquid

29 second dispensing container

30 second liquid

31 jet

32 place of meeting

33 jet

34 addition medium

35 capsule

36 vessel

37 border

38 control unit

39 decompression chamber

39a input

40 decompression chamber

41 conditioning container

41a input

41b output

42 line device

43 first line connection

44 second line connection

45 recirculation line connection

46 recirculation line connection

47 line section

48 feed pump

49 4/2-way valve

49a first port

49b second port

49c third port

50 line part

51 line part

52 line part

53 stop valve

54 line part

55 stop valve

56 valve

57 line part

58 line part

59 line part

60 stop valve

61 opening

62 line part

63 stop valve

64 line connection

65 line part

66 valve

67 CO₂ container

68 line

69 line part

70 pressure controller

71 pressure controller

72 filling opening

73 line part

1. Drink producing apparatus comprising:
a dispensing unit for dispensing liquid from the drink producing apparatus,
a dispensing container, which is formed for receiving a liquid addable to a drink by the drink producing apparatus in a first liquid state,
a conditioning container, in which the liquid can be conditioned into a second liquid state different from the first liquid state,
a line device, which
comprises a first line connection, wherein this first line connection is connected to the dispensing container and the dispensing unit,
comprises a second line connection, wherein this second line connection is connected to the dispensing container and the conditioning container, and
comprises a recirculation line connection, wherein this recirculation line connection is connected to an input of the conditioning container and to an output of the conditioning container, wherein
the line device comprises a line section, wherein this line section is a constituent of the first line connection and the second line connection and the recirculation line connection.

2. Drink producing apparatus according to claim 1, wherein the line device comprises a further recirculation line connection, wherein this further recirculation line connection is connected to an input of the dispensing container and to an output of the dispensing container, wherein
the line section is a constituent of the first line connection and the second line connection and the recirculation line connection and the further recirculation line connection.

3. Drink producing apparatus according to claim 1, comprising:
a feed pump, wherein the feed pump is arranged in the line section.

4. Drink producing apparatus according to claim 1, comprising:
a 4/2-way valve, wherein the 4/2-way valve is arranged in the line section.

5. Drink producing apparatus according to claim 4, wherein the 4/2-way valve comprises a first port, and the first line connection comprises a line part, wherein the line part opens into the first port, and
comprises a second port, and the recirculation line connection comprises a line part, wherein the recirculation line part opens into the second port.

6. Drink producing apparatus according to claim 5, wherein the line part of the first line connection is a constituent of a further recirculation line connection of the line device, wherein this further recirculation line connection is connected to an input of the dispensing container and to an output of the dispensing container.

7. Drink producing apparatus according to claim 5, wherein the 4/2-way valve comprises a third port, into which a drain line of the line device opens.

8. Drink producing apparatus according to claim 5, comprising:
a stop valve with a first port and with a second port, wherein the line section opens into the first port and a line part opening into the conditioning container opens into the second port.

9. Drink producing apparatus according to claim 5, comprising:
a further stop valve with a first port and with a second port, wherein the line section opens into the first port, and a line part opens into the second port, which is a constituent of the first line connection.

10. Drink producing apparatus according to claim 1, comprising:
a decompression chamber for pressure reduction of the liquid in the conditioning container, wherein the decompression chamber is connected to the conditioning container by a line part of the line connection.

11. Drink producing apparatus according to claim 10, comprising:
a stop valve, which is arranged in the line part, which extends between the decompression chamber and the conditioning container.

12. Drink producing apparatus according to claim 10, wherein the decompression chamber is thermally coupled to a further recirculation line connection of the line device, wherein this further recirculation line connection is connected to an input of the dispensing container and to an output of the dispensing container.

13. Drink producing apparatus according to claim 1, wherein the line connection comprises a further recirculation line connection, wherein this further recirculation line connection is connected to an input of the dispensing container and to an output of the dispensing container, and the drink producing apparatus has a 3/2-way valve, which is connected to the further recirculation line connection by a port and is connected to the dispensing unit by a further port.

14. Drink producing apparatus according to claim 13, wherein the 3/2-way valve is connected to a line part of the line device by a third port, wherein this line part is connected to the dispensing unit.

15. Drink producing apparatus according to claim 10, wherein the decompression chamber is connected to the dispensing unit by a line part of the line device, and a stop valve is arranged in this line part.

16. Drink producing apparatus according to claim 1, wherein the second liquid state is a carbonized state of the liquid.

17. Household refrigeration apparatus comprising a housing, in which a receiving space for food is formed, and a drink producing apparatus comprising:
a dispensing unit for dispensing liquid from the drink producing apparatus,
a dispensing container, which is formed for receiving a liquid addable to a drink by the drink producing apparatus in a first liquid state,
a conditioning container, in which the liquid can be conditioned into a second liquid state different from the first liquid state,
a line device, which
comprises a first line connection, wherein this first line connection is connected to the dispensing container and the dispensing unit,
comprises a second line connection, wherein this second line connection is connected to the dispensing container and the conditioning container, and
comprises a recirculation line connection, wherein this recirculation line connection is connected to an input of the conditioning container and to an output of the conditioning container, wherein
the line device comprises a line section, and this line section is a constituent of the first line connection and the second line connection and the recirculation line connection.

18. Drink producing apparatus comprising:
a dispensing unit for dispensing liquid from the drink producing apparatus,
a dispensing container, which is formed for receiving a liquid addable to a drink by the drink producing apparatus in a first liquid state,
a conditioning container, in which the liquid can be conditioned into a second liquid state different from the first liquid state,
a line device, which
comprises a first line connection, wherein this first line connection is connected to the dispensing container and to the dispensing unit,
comprises a second line connection, wherein this second line connection is connected to the dispensing container and the conditioning container, and
comprises a recirculation line connection, wherein this recirculation line connection is connected to an input of the dispensing container and to an output of the dispensing container, wherein
the line device comprises a line section, and this line section is a constituent of the first line connection and the second line connection and the recirculation line connection.

19. Household refrigeration apparatus comprising a housing, in which a receiving space for food is formed, and a drink producing apparatus comprising:
a dispensing unit for dispensing liquid from the drink producing apparatus,
a dispensing container, which is formed for receiving a liquid addable to a drink by the drink producing apparatus in a first liquid state,
a conditioning container, in which the liquid can be conditioned into a second liquid state different from the first liquid state,
a line device, which
comprises a first line connection, wherein this first line connection is connected to the dispensing container and the dispensing unit,
comprises a second line connection, wherein this second line connection is connected to the dispensing container and the conditioning container, and
comprises a recirculation line connection, wherein this recirculation line connection is connected to an input of the dispensing container and to an output of the dispensing container, wherein
the line device comprises a line section, and this line section is a constituent of the first line connection and the second line connection and the recirculation line connection.

20. Drink producing apparatus comprising:
a dispensing unit for dispensing liquid from the drink producing apparatus,
a dispensing container, which is formed for receiving a liquid addable to a drink by the drink producing apparatus in a first liquid state,
a conditioning container, in which the liquid can be conditioned into a second liquid state different from the first liquid state,
a line device, which comprises line connections to the dispensing unit, the dispensing container and the conditioning container, wherein
at least one of the line connections is a recirculation line connection, in which a liquid led therein can be recirculated without leading to the dispensing unit, and
at least one further line connection is a non-recirculation line connection, in which a liquid led therein cannot be recirculated, wherein
the recirculation line connection and the non-recirculation line connection are thermally coupled for transferring the temperature level of the recirculation line connection to the non-recirculation line connection.

21. Household refrigeration apparatus comprising a housing, in which a receiving space for food is formed, and a drink producing apparatus comprising:
a dispensing unit for dispensing liquid from the drink producing apparatus,
a dispensing container, which is formed for receiving a liquid addable to a drink by the drink producing apparatus in a first liquid state,
a conditioning container, in which the liquid can be conditioned into a second liquid state different from the first liquid state,
a line device, which has line connections to the dispensing unit, the dispensing container and the conditioning container, wherein
at least one of the line connections is a recirculation line connection, in which a liquid led therein can be recirculated without leading to the dispensing unit, and
at least one further line connection is a non-recirculation line connection, in which a liquid led therein cannot be recirculated, wherein
the recirculation line connection and the non-recirculation line connection are thermally coupled for transferring the temperature level of the recirculation line connection to the non-recirculation line connection.
